(19) United States
(12) Patent Application Publication
(10) Pub. No.: US 2007/0061168 A1
(43) Pub. Date: Mar. 15, 2007

(54) Method and apparatus for evaluating variations between health care service providers

(76) Inventor: Emily Hamilton, Verdun (CA)

Correspondence Address: LADAS & PARRY, 26 WEST 61ST STREET, NEW YORK, NY, 10023, US

(21) Appl. No.: 10/557,439

(22) PCT Filed: Aug. 12, 2004
(86) PCT No.: PCT/CA04/01499

§ 371 Date: Nov. 18, 2005

Related U.S. Application Data
(60) Provisional application No. 60/494,086, filed on Aug. 12, 2003.

(51) Int. Cl. G06F 19/00; G05B 13/02

(52) U.S. Cl. 705/3; 700/28

(57) ABSTRACT

A method and an apparatus for evaluating variations in a certain outcome between a given health care service provider and a reference health care service provider. The reference health care service provider is characterized and the given health care service provider are characterized respectively by a first and second rate of occurrence of the certain outcome. The apparatus comprises an input, a processing unit and an output. The input receives a plurality of records associated to respective patients treated by the given health care service provider that include a plurality of data elements indicative of respective determinant factors related to the certain outcome. The processing unit processes the plurality of records to identify at least one determinant factor as a candidate for causing a variation between the first and second rates of occurrence of the certain outcome. The output releases a signal conveying the at least one determinant factor.

### FIELD OF THE INVENTION

The present invention relates generally to the field of health care services. More specifically, the present invention relates to a method for identifying one or more factors that are candidates for causing a variation in a health care service provided by two or more health care service providers.

### BACKGROUND OF THE INVENTION

It is generally accepted that the quality of health care provided by various health care service providers, such as hospitals, is not standardised, and that the quality of care received by patients at one hospital is different from the quality of care received by patients at a different hospital. The same is generally also true for the health care services provided by individual health care practitioners.

While the lack of standardised health care can be frustrating for patients, it can have significant financial consequences for health care service providers. For example, a hospital that has a higher-than-average rate of performing an expensive health care service, such as a certain type of surgery, might be dispensing more money than is necessary. In addition, that hospital might be subjecting its patients to a surgery that might not be the best treatment for the patient. This is particularly relevant for hospitals that are funded by using public sector funds and who therefor cannot transfer the cost of these expensive health care services to the patients.

One such type of health care service is the delivery of babies by cesarean section. Generally, the rate of mothers who deliver their babies by cesarean section differs from one hospital to the next. Although a portion of this variation may be attributed to the patients themselves, the hospital practices may also influence the variations in the rate. Since the cost of performing cesarean sections is typically higher than the cost associated with a vaginal birth, it is desirable to reduce the occurrence of such medical interventions provided such a reduction does not harm the health of the mother or the foetus.

Existing systems offer no suitable solution for evaluating variations between health care service providers in order to assist health care service providers in changing their practices to provide a more uniform standard of care, reduce costs and improve the quality of care being given to their patients.

Therefore, in the context of the above, it is apparent that there is a need in the industry to provide a method and system for evaluating variations between health care service providers in order to alleviate, at least in part, problems associated with the existing methods and systems.

### SUMMARY OF THE INVENTION

In accordance with a first broad aspect, the invention provides an apparatus for evaluating variations in a certain outcome between a given health care service provider and a reference health care service provider. The reference health care service provider is characterized by a first rate of occurrence of the certain outcome and the given health care service provider is characterized by a second rate of occurrence of the certain outcome. The apparatus comprises an input, a processing unit and an output. The input receives a plurality of records associated to respective patients treated by the given health care service provider. Each record includes a plurality of data elements associated to respective determinant factors related to the certain outcome. The processing unit processes the plurality of records to identify at least one determinant factor as a candidate for causing a variation between the second rate of occurrence of the certain outcome and the first rate of occurrence of the certain outcome. The output then releases a signal conveying the candidate determinant factor.

In accordance with a specific implementation, the processing unit is adapted to determine the candidate determinant factor at least in part on the basis of an estimate of the amount of influence that the candidate determinant factor has on the variation between the first and second rates of occurrence of the certain outcome.

In accordance with a specific example of implementation, the processing unit is operative for processing the plurality of records to derive an impact data element that is associated to the candidate determinant factor. The impact data element is indicative of an estimate of the amount of influence that the candidate determinant factor has on the variation between the first and second rates of occurrence of the certain outcome.

In accordance with another specific example of implementation, the candidate determinant factor is a modifiable determinant factor that is selected from the set consisting of patient characteristics, medical practices and a caregiver's threshold for intervention.

In accordance with yet another specific example of implementation, the processing unit is operative for processing the plurality of records to identify a set of determinant factors that are candidates for causing a variation between the first and second rates of occurrence of the certain outcome. The processing unit is further operative for deriving impact data elements associated to respective determinant factors in the set of determinant factors. Each impact data element is indicative of an amount of influence that its associated determinant factor has on the variation between the first and second rates of occurrence of the certain outcome. Alternatively, the processing unit is operative for deriving an impact data element associated to the set of determinant factors. In such a case, the impact data element is indicative of the influence that the set of determinant factors has on the variation between the first and second rates of occurrence of the certain outcome.

In accordance with another broad aspect, the invention provides a method for evaluating variations in a certain outcome between a given health care service provider and a reference health care service provider. The reference health care service provider is characterized by a first rate of occurrence of the certain outcome and the given health care service provider is characterized by a second rate of occurrence of the certain outcome. The method comprises receiving a plurality of records associated to respective patients treated by the given health care service provider. Each record includes a plurality of data elements associated to respective determinant factors related to the certain outcome. The method further comprises processing the plurality of records to identify at least one determinant factor that is a candidate for causing a variation between the second rate of occurrence of the certain outcome and the first rate of occurrence of the certain outcome and releasing a signal conveying the determinant factor.

In accordance with another broad aspect, the present invention provides a server system for evaluating variations in a certain outcome between a given health care service provider and a reference health care service provider. The reference health care service provider is characterized by a first rate of occurrence of the certain outcome and the given health care service provider is characterized by a second rate of occurrence of the certain outcome. The server system stores a program element for execution by a CPU. The program element comprises a first program element component for receiving a plurality of records associated to respective patients treated by the given health care service provider. Each record includes a plurality of data elements associated to respective determinant factors related to the certain outcome. The program element further comprises a second program element component for processing the plurality of records in order to identify at least one determinant factor that is a candidate for causing a variation between a rate of occurrence of the certain outcome at the given health care service provider and at the reference health care service provider. The program element further comprises a third program element component for transmitting the determinant factor identified to a client system so that the determinant factor is conveyed to a user.

In accordance with another broad aspect, the invention provides a client-server system for evaluating variations in a certain outcome between a given health care service provider and a reference health care service provider. The reference health care service provider is characterized by a first rate of occurrence of the certain outcome and the given health care service provider is characterized by a second rate of occurrence of the certain outcome. The client-server system comprises a client system and a server system. The client system and the server system are operative to exchange messages over a data network. The server system stores a program element for execution by a CPU. The program element comprises a first program element, a second program element, a third program element and a fourth program element. The first program element component is for receiving a plurality of records associated to respective patients treated by the given health care service provider, wherein each record includes a plurality of data elements associated to respective determinant factors related to the certain outcome. The second program element component is for processing the plurality of records in order to identify at least one determinant factor that is a candidate for causing a variation between a rate of occurrence of the certain outcome at the given health care service provider and a reference health care service provider. The third program element component is for sending messages to the client system for causing the client system to display information on the basis of the data indicative of the candidate determinant factor. The fourth program element component is for receiving a message from the server system for displaying the candidate determinant factor to a user.

In accordance with another broad aspect, the present invention provides a computer readable storage medium including a program element suitable for execution by a computing apparatus for evaluating variations in a certain outcome between a given health care service provider and a reference health care service provider. The reference health care service provider is characterized by a first rate of occurrence of the certain outcome and the given health care service provider is characterized by a second rate of occurrence of the certain outcome. The computing apparatus comprises a memory unit and a processor. The processor receives a plurality of records associated to respective patients treated by the given health care service provider. Each record includes a plurality of data elements associated to respective determinant factors related to the certain outcome. The processor processes the plurality of records to identify at least one determinant factor that is a candidate for causing a variation between the second rate of occurrence of the certain outcome and the first rate of occurrence of the certain outcome. The processor is further operative for releasing a signal conveying the candidate determinant factor.

In accordance with another broad aspect, the present invention provides a computer readable storage medium for storing a program element for execution by a CPU. The program element is suitable for use in providing information related to variations in a certain outcome between a given health care service provider and a reference health care service provider. The reference health care service provider is characterized by a first rate of occurrence of the certain outcome and the given health care service provider is characterized by a second rate of occurrence of the certain outcome. The program element comprises a first program element component, a second program element component and a third program element component. The first program element component is operative for causing a computer to deliver first information to a user. The first information prompts the user to enter at the computer a plurality of records associated to respective patients treated by the given health care service provider. Each record includes a plurality of data elements associated to respective determinant factors related to the certain outcome. The second program element component is responsive to the plurality of records for transmitting data over a computer network for conveying the plurality of records to a server computing unit. The third program element component is responsive to a message that includes data indicative of at least one determinant factor received from the server computing unit for causing the computer to convey the determinant factor. The conveyed determinant factor is a candidate for causing a variation between the second rate of occurrence of the certain outcome and the first rate of occurrence of the certain outcome to the user of the computer.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 shows a high-level functional block diagram of a system for evaluating variations between health care service providers, with respect to a certain outcome, in accordance with a specific example of implementation of the present invention;

FIG. 2 shows a flow diagram of a process for evaluating variations between health care service providers, with respect to a certain outcome, in accordance with a specific example of implementation of the present invention;

FIG. 3A shows a specific, non-limiting example of implementation of a graphical user interface providing a visual representation of information conveyed by the signal released by the process described in FIG. 2;

FIG. 3B shows the graphical user interface shown in FIG. 3A with a drop down button activated;

FIG. 4 shows a functional block diagram of a computing unit for evaluating variations between health care service providers, with respect to a certain outcome, in accordance with a specific example of implementation of the present invention;

FIG. 5 shows a functional block diagram of a client-server system for evaluating variations between health care service providers, with respect to certain outcome, in accordance with an alternative example of implementation of the present invention;

FIG. 6 shows a high-level conceptual block diagram of a program element for implementing the process shown in FIG. 2 in accordance with a specific example of implementation of the present invention.

Other aspects and features of the present invention will become apparent to those of ordinarily skill in the art, upon review of the following description of specific embodiments of the invention in conjunction with the accompanying figures.

### DETAILED DESCRIPTION

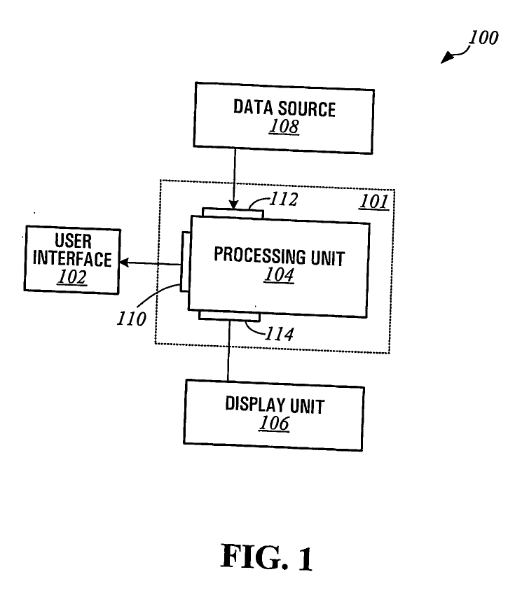

Shown in FIG. 1 is a system 100, in accordance with a specific example of implementation of the present invention. The system 100 is operative to evaluate variations in the rate of occurrence of a certain outcome between a given health care service provider and a reference health care service provider, wherein the given health care service provider is characterised by a first rate of occurrence of the certain outcome, and the reference health care service provider is characterised by a second rate of occurrence of the certain outcome. More specifically, the system 100 is operative to identify a potential cause for the variation in the rate of occurrence of the certain outcome between the two health care service providers, and is further operative to derive an estimate of the amount of influence the potential cause has on the variation in the rate of occurrence of the certain outcome.

As used herein, the term “certain outcome” is any medical procedure or health condition that occurs as a result of a service, or lack of service, provided by a health care service provider. Most services provided to a patient have associated rates of occurrence for outcomes. For example, in the non-limiting field of obstetrics, when the service provided to a patient is the delivery of a baby, an associated certain outcome is that the baby will be delivered by cesarean section. As a second example, when the service provided to a patient is the delivery of a baby, and the baby has a high level of base deficit in the arterial cord blood, an associated certain outcome is that the baby will develop metabolic acidosis. Although the above examples relate to the specific outcomes of delivery by cesarean section, and metabolic acidosis, many other outcomes are included within the scope of the invention, such as maternal trauma, new-born trauma, date and time of birth, and measured outcomes such as Apgar scores. The term “obstetrics patient” as used herein refers to either one of a pregnant woman, a fetus or a new-born.

Since there are a number of possible outcomes associated with a given health care service provided by a health care service provider, each health care service provider is characterised by a specific rate of occurrence for each certain outcome. For example, referring back to the case of delivery by cesarean section, a first health care service provider may be characterised by a 15% rate of delivery by cesarean section, and a second health care service provider may be characterised by a 10% rate of delivery by cesarean section. It should be understood that the percentages given above are for the sake of example only, and do not necessarily reflect accurate rates of occurrence of cesarean sections.

An advantage of the system 100, is that it is operative to compare data associated to patients treated by a given health care service provider with data associated to a reference health care service provider, in order to identify one or more potential causes for the variation in the rate of occurrence of a certain outcome between the two. Optionally, as mentioned above, the system 100 is further operative to derive the amount of influence the one or more potential causes have on the variation in the rate of occurrence. Advantageously, this enables the given health care service provider to determine whether that potential cause can be modified in order to alter the rate of occurrence of the certain outcome.

As used herein, the term “given health care service provider” refers to any provider of health care to patients, such as an individual physician, a hospital, a clinic or an EMO or any collection of the previously mentioned health care service providers. The collection of health care service providers may be grouped together by geographical region, for example, such that the given health care service provider could be all the hospitals in a certain city, state or province or country. The term “reference health care service provider” refers to any provider of health care to patients such as an individual physician, a hospital, a clinic, an HMO, or any collection of the previously mentioned health care service providers. Alternatively, the reference health care service provider can be an established benchmark against which the given health care service providers may be compared.

As shown in FIG. 1, the system 100 comprises a user interface 102, a data storage unit 108, an apparatus 101 and a display unit 106.

The user interface 102 is coupled to apparatus 101 in order to enable a user to input data into apparatus 101. The user interface can be a keyboard, a mouse, a touch sensitive screen, a voice recognition unit, or any other type of user interface known in the art. In accordance with a specific example of implementation, the user is enabled to use user interface 102 in order to enter into apparatus 101 a plurality of records associated to respective patients.

Alternatively, or in addition to user interface 102, the plurality of records can be provided to apparatus 101 from a data source 108. Data source 108 can be in the form of a physical storage medium such as a CD, a floppy disk or a data base contained on a hard drive, or alternatively, can be a remote data source that supplies data to apparatus 101 via the internet or via a wireless link.

The plurality of records that are provided to apparatus 101 are each associated to a respective patient. The plurality of records can be hospital treatment records, insurance claims records, or any suitable type of record that would include the information described below. More specifically, in a non-limiting implementation, each record includes a plurality of data elements that are associated to respective determinant factors. These determinant factors can include patient specific determinant factors, health care process determinant factors and/or determinant factors relating to a caregiver's threshold of intervention. In the specific example of an obstetrics patient, some non-limiting examples of patient specific determinant factors include socioeconomic determinant factors, such as years of schooling, marital status, postal code, as well as medical determinant factors, such as, for example, maternal height and weight, baby weight, gestational age, infections, impaired glucose tolerances or diabetes, specific diseases and abnormal placentation. Some non-limiting examples of health care process determinant factors include cervical status on admission, induction of labor, use and timing of epidural, time and findings of each pelvic exam, status and time when decision for cesarean section was taken, cervical dilation, effacement, station, hours of arrest, economic model for payment of services and medical manpower model. A non-limiting example of a determinant factor relating to a caregiver's tolerance for intervention includes the time at which the caregiver is intervened with the natural vaginal birth for example by the administration of certain medication to induce labour. Each of these determinant factors is a possible candidate for causing the variation in the rate of occurrence of the certain outcome between the two health care service providers being compared. In addition, multiple determinant factors may each contribute to the variation in the rate of occurrence of the certain outcome to a different degree and therefor have a different impact on that variation.

The person skilled in the art will appreciate that some determinant factors are modifiable determinant factors. Typically, the modifiable determinant factors are determinant factors relating to medical practices and a caregiver's threshold for intervention. For example, the use and timing of an epidural is modifiable, and so is the time when the decision to perform a cesarean section was taken. If the system 100 determines that a modifiable determinant factor is a potential cause for a high rate of occurrence of cesarean sections at a given health care service provider, it is possible for the given health care service provider to modify their approach to that determinant factor, which might cause a reduction in the rate of occurrence of the delivery by cesarean section.

As shown in FIG. 1, the apparatus 101 includes two inputs 110 and 112, a processing unit 104 and an output 114. The first input 110 is for receiving data from the user interface 102 and the second input 112 is for receiving data from data source 108. The data includes the plurality of records described above. In the case where system 100 includes only user interface 102 or data source 108, then it should be understood that apparatus 101 includes only one input.

The processing unit 104 is operative to process the data received at inputs 112, and 114, in order to identify a determinant factor that is a candidate for causing a variation between the rate of occurrence of the certain outcome between the given health care service provider and a reference health care service provider. In order to identify the determinant factor, the processing unit compares the plurality of records associated to patients treated by the given health care service provider with information associated to the reference health care service provider.

The information relating to the reference health care service provider can be records associated to patients treated by the reference health care service provider or can be established benchmark parameters relating to the certain outcome. The information associated to the reference health care service provider can be stored within the processing unit 104, or alternatively can be input into processing unit 104 at the same time as the records associated with the given health care service provider. It should be understood that the records associated to patients treated by the given health care service provider and the information associated to the reference health care service provider that are compared in order to identify a determinant factor, are also associated with the certain outcome being analysed.

In a first specific example of implementation, records that are associated with patients treated by the given health care service provider are provided to apparatus 101. In such a case, information associated with the reference health care service provider is already stored within the processing unit 104.

In a second specific example of implementation, a plurality of records associated with the given health care service provider as well as information relating to the reference health care service provider are provided to apparatus 101.

In a third specific example of implementation, the plurality of records input into apparatus 101 include a plurality of records associated to patients treated by multiple different health care service providers and associated to a plurality of outcomes. Therefore, prior to performing any additional processing, the processing unit 104 extracts from the plurality of records the records which associated with the given health care service provider that are also associated with the certain outcome being analysed, as well as the records associated to the reference health care service provider (if not already stored within processing unit 104) that are also associated with the certain outcome being analysed. In the non-limiting example where the certain outcome is delivery by cesarean section, after extracting the relevant records, the processing unit 104 is left with a plurality of records that are each associated to respective women who has delivered by cesarean section at either the given health care service provider or at the reference health care service provider.

Once the processing unit 104 has received the plurality of records that are associated with respective patients treated by the given health care service provider, and that are associated with the certain outcome, the processing unit 104 processes these records in order to identify at least one determinant factor contained in the plurality of records that could be a candidate for causing the variation in the rate of occurrence of the certain outcome.

In a non-limiting implementation, the processing unit 104 processes these records in order to derive impact data elements associated to the determinant factors in a set of determinant factors. Each impact data element is indicative of an amount of influence that its associated candidate determinant factor has on the variation in the rate of occurrence of the certain outcome between the given health care service provider and the reference health care service provider. Preferably, an impact data element indicates the amount of influence that its associated candidate determinant factor has on the variation in the rate of occurrence of the certain outcome independently from the other determinant factors in the set of determinant factors. The impact data elements can include percentage values, or alternatively can include ranking values. Optionally, the processing unit 104 then selects a certain determinant factor in the set of determinant factors at least in part on the basis of the impact data elements. Other criteria may also be used such as, for example, whether the determinant factors are modifiable factors.

In a non-limiting implementation, where the impact data elements include percentage values, the processing unit 104 is adapted to determine:
that the determinant factor indicative of the time when the decision to perform a cesarean section was taken contributed to 50% of the difference between the rate of occurrence of the cesarean section;
that the determinant factor indicative of the timing of the epidural contributed to 20% of the difference between the rate of occurrence of the cesarean section;
and that the remaining 30% of the difference between the rate of occurrence of the cesarean section was due to patient characteristics such as the mother's height, weight, age etc.

In an alternative non-limiting implementation, where the impact data elements include ranking values, the processing unit 104 is adapted to determine:
RANK 1: determinant factor indicative of the time when the decision to perform a cesarean section was taken;
RANK 2: determinant factor indicative of the timing of the epidural;
RANK 3: patient characteristics such as the mother's height, weight, age etc.
   Where RANK K indicates a greater contribution than RANK M for K<M.

On the basis of the above information, the processing unit 104 releases all three determinant factors or may choose to release the determinant factor which had the greatest contribution to the difference between the rate of occurrence of the cesarean section. Alternatively, the processing unit 104 may release only the determinant factors that are modifiable. This information is conveyed to the user of the system. Advantageously, on the basis of this information, the given health care service provider may choose to modify its approach to the time when the decision to perform a cesarean section was taken (or the timing of the epidural), in order to cause a reduction (or and increase) in the rate of occurrence of the delivery by cesarean section.

In an alternative example of implementation of the present invention, the processing unit 104 is operative for processing the records that are associated with the given health care service provider and the information associated to the reference health care service provider in order to identify a set of determinant factors that are candidates for causing a variation in the rate of occurrence of the certain outcome between the two health care service providers. In the case where the processing unit 104 is operative for deriving a set of determinant factors, the processing unit 104 can further derive an impact data element associated to the set of determinant factors that is indicative of the influence that the set of determinant factors has on the variation in the rate of occurrence of the certain outcome at the two health care service providers. For instance, the impact data element would indicate the combined (or joint) effect of the timing of the epidural and the time when the decision to perform a cesarean section was taken on the difference in the cesarean rate. Alternatively, the processing unit 104 can derive multiple impact data elements that are each associated to respective determinant factors in the set of determinant factors. In such a case, each impact data element is indicative of an amount of influence that its associated determinant factor has on the variation in the rate of occurrence of the certain outcome at the two health care service providers.

As mentioned above, in order to identify a candidate determinant factor, the processing unit 104 compares the data elements in the records associated to patients treated by the given health care service provider with the information associated with the reference health care service provider. In a non-limiting implementation, the processing unit 104 is adapted to apply statistical methods to derive impact data elements associated to individual determinant factors in a set of determinant factors as well as to subsets of determinant factors selected from the set of determinant factors. Each impact data element indicates an estimate of the influence that the corresponding determinant factor (or subset of determinant factors) has on the variation in variation in the rate of occurrence of an outcome. The estimated influence may be expressed in absolute terms such as a percentage or in relative terms such as a ranking. One or more candidate determinant factors may then be selected by the processing unit 104 on the basis of the impact data elements. Preferably the determinant factors having the highest impact on the variation in rate of the outcome will be selected however other criteria may also be used in the selection process. Estimating an amount of influence that a variable (or a combination of variables) has on a result may be done according to statistical methods that are well known in the art. Since such methods are well known they will not be described further here. Some non-limiting examples of statistical methods that the processing unit 104 can use in order to identify a candidate determinant factor include pattern recognition methods, data correlation methods, linear regression, correlation coefficients, multivariate analysis, frequency distributions, random effects models and any other suitable statistical analysis methods known in the art.

Once the processing unit 104 has identified at least one determinant factor as a candidate for causing the variation in the certain outcome, the processing unit 104 releases a signal conveying the at least one determinant factors through output 108 to display unit 106. In a specific example of implementation, the processing unit 104 also releases a signal conveying the corresponding impact data elements to display unit 106. Display unit 106 is coupled to the apparatus 101 and is operative to display information derived by apparatus 101 in response to the signal released by processing unit 104. The display unit 106 may be in the form of a display screen, a printer or any other suitable device for conveying to a user the determinant factor. In a non-limiting example of implementation, the display unit 106 includes a display monitor to display the determinant factor. In a second non-limiting example of implementation, the display unit 106 includes a printer device for providing a paper print out of the determinant factor derived by processing unit 104.

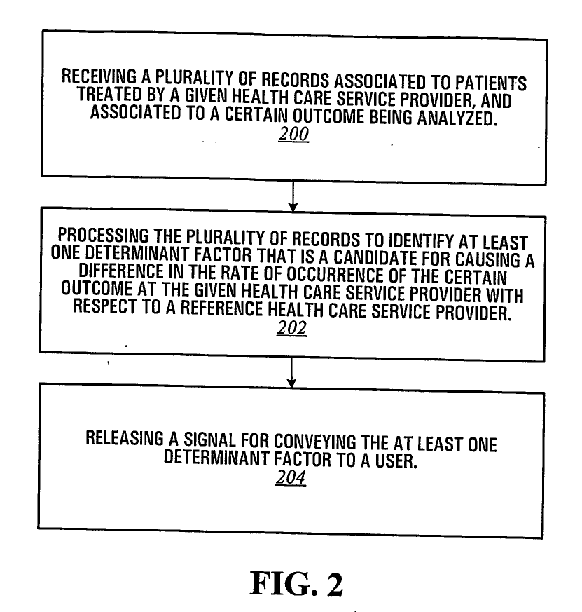

The process used by the processing unit 104 for evaluating variations in the rate of occurrence of a certain outcome between a given health care service provider and a reference health care service provider, are described with reference to FIG. 2. At step 200, the processing unit 104 is operative for receiving a plurality of records that are associated to patients treated by the given health care service provider, and that are also associated with the certain outcome being analysed. As described above, each record includes a plurality of data elements that are indicative of respective determinant factors related to the certain outcome. At step 202, the processing unit 104 is operative for processing the plurality of records in order to identify at least one determinant factor that is a candidate for causing the variation in the rate of occurrence of the certain outcome. Finally, at step 204, the processing unit 104 is operative for releasing a signal conveying the at least one determinant factor to a user.

Example Relating to the Certain Outcome of Delivering a Baby Via Cesarean Section

Described below is a non-limiting example of how the system 100 can be used in order to identify a determinant factor that is a candidate for causing a given health care service provider to have a significantly higher rate of occurrence of delivery by cesarean section than a reference health care service provider. For the sake of the present example, let us assume that the given health care service provider is hospital A and has a 30% rate of occurrence of delivery by cesarean section, and that the reference health care service provider is hospital B and has only a 12% rate of occurrence of delivery by cesarean section.

Since a delivery by cesarean section is generally significantly more expensive to perform than a vaginal delivery, it is desirable for hospital A to be able to determine a determinant factor that is causing its high rate of delivery by cesarean section, such that, if possible, it can make changes in order to reduce this rate. By reducing the rate of delivery by cesarean section, hospital A could reduce its costs, which would allow it to invest the saved expenses into other sectors such as additional rooms and better equipment for example. In addition, reducing the rate of delivery by cesarean sections would also decrease the number of women undergoing major surgery in order to deliver their babies.

At step 200, as described above, the processing unit 104 receives a plurality of records that are associated to respective patients that gave birth by cesarean section at hospital A. In this specific example, records such as the ones shown in Table 1 are input into processing unit 104. It should be understood that the values displayed in Table 1 are only provided for illustrative purposes and do not illustrate actual values in a patient records.

TABLE 1
RECORDS FOR PATIENTS TREATED BY HOSPITAL A

| | | Gesta- | | When the decision to |
|---|---|---|---|---|
| | | tional | Timing of | perform cesarean |
| Age | Weight | Age | epidural | section was taken |
| 23 | 130 lbs | 40 weeks | 2 hrs after onset of | 3 hrs after onset of |
| | | | contractions | contractions |
| 23 | 145 lbs | 38 weeks | 1 hr after onset of | 2.5 hrs after onset of |
| | | | contractions | contractions |
| 24 | 135 lbs | 41 weeks | 1.5 hrs after onset | 3 hrs after onset of |
| | | | of contractions | contractions |
| 23 | 160 lbs | 40 weeks | 1 hr after onset of | 2.5 hrs after onset of |
| | | | contractions | contractions |
| 24 | 140 lbs | 42 weeks | 1.5 hrs after onset | 2 hrs after onset of |
| | | | of contractions | contractions |

Depending on whether or not the processing unit 104 already has records relating to the reference health care service provider, records such as the ones shown in Table 2 are also provided to processing unit 104. It should be understood that the values displayed in Table 2 are also only provided for illustrative purposes. Each of the records in Table 1 and Table 2 contain data elements associated to determinant factors relating to the delivery by cesarean section. In this specific example, the determinant factors are age, weight, gestational age, timing of the epidural and when the decision for cesarean section was taken. Each of these determinant factors is a candidate for causing the variation in the rate of occurrence of delivery by cesarean section between hospital A and hospital B.

TABLE 2
RECORDS FOR PATIENTS TREATED BY HOSPITAL B

| | | Gesta- | | When the decision to |
|---|---|---|---|---|
| | | tional | Timing of | perform cesarean |
| Age | Weight | Age | epidural | section was taken |
| 23 | 135 lbs | 41 weeks | 2 hrs after onset of | 6 hrs after onset of |
| | | | contractions | contractions |
| 24 | 155 lbs | 39 weeks | 1.5 hr after onset | 7 hrs after onset of |
| | | | of contractions | contractions |
| 24 | 135 lbs | 40 weeks | 2 hrs after onset of | 8 hrs after onset of |
| | | | contractions | contractions |
| 25 | 150 lbs | 42 weeks | 1.5 hr after onset | 6 hrs after onset of |
| | | | of contractions | contractions |
| 24 | 155 lbs | 42 weeks | 1.5 hrs after onset | 7 hrs after onset of |
| | | | of contractions | contractions |

At step 202, the processing unit 104 processes the plurality of records received at step 200, in order to identify one or more determinant factors as a cause for a variation in the rate of occurrence of delivery by cesarean section. As mentioned above, the processing unit 104 uses known statistical methods in order to select one or more determinant factors.

In a very simple example, the processing unit 104 may compare the average of each determinant factor in Table 1, with the average of the corresponding determinant factor in Table 2.

In Table 1:
average age is 23.4;
average weight is 142 lbs;
average gestational age is 40.2 weeks;
average timing of the epidural is 1.4 hours after the onset of contractions;
average time at which decision to perform cesarean section was taken is 2.6 hours after the onset of contractions.

In Table 2:
average age is 24;
average weight is 146 lbs;
average gestational age is 40.8 weeks;
average timing of the epidural is 1.6 hours after the onset of contractions;
average time at which decision to perform cesarean section was taken is 6.8 hours after the onset of contractions.

Using basic mathematics, it can be seen that the largest difference between the averages of the determinant factors is the difference between when the decision to perform cesarean sections was taken. For hospital A, the average time was 2.6 hours after the onset of contractions and for hospital B, the average time was 6.8 hours after the onset of contractions. Therefore, in the case of the plurality of records shown above in Tables 1 and 2, it can be seen that the most likely determinant factor that is a candidate for causing the variation in the rate of occurrence of delivery by cesarean section, is the time when the decision to perform a cesarean section was taken. The decision to perform a cesarean was performed approximately 3-4 hours later at hospital B than at hospital A, and as such, this could be a candidate for causing the high rate of delivery by cesarean section at hospital A. This determinant factor could be assigned RANK #1. Similarly, the other determinant factors may also be assigned respective ranks depending on the amount of influence each has on the variability of the rate of occurrence of delivery by cesarean section.

It will be appreciated that the above example is a greatly simplified approach for comparing the records of hospital B and hospital A. Actual implementations may use more advanced statistical methods for determining the influence of each determinant factor (or combination of determinant factors) has of a variability of the rate of occurrence of delivery by cesarean section.

In an alternative example, frequency distribution techniques could are also used in order to identify a candidate determinant factor.

In an alternative example the patient records in Table 1 are compared with established benchmark values, such as the ones shown in Table 3 below. In this example, at step 200, as described above, the processing unit 104 receives the plurality of records that are associated to respective patients that gave birth by cesarean section at hospital A, such as the records shown in Table 1 above. The established benchmark values shown in Table 3 can be pre-stored in the processing unit 104, or alternatively these records can also be input into processing unit 104 at the same time as the records in Table 1.

TABLE 3
ESTABLISHED BENCHMARK VALUES

| | | | | When the decision |
|---|---|---|---|---|
| | | Gesta- | | to perform cesar- |
| | | tional | Timing of | ean section was |
| Age | Weight | Age | epidural | taken |
| 20-25 | 100-150 | 38-42 | 1-2 hrs after onset | 6-8 hrs after onset |
| | lbs | weeks | of contractions | of contractions |
| 20-25 | 150-180 | 38-42 | 1-3 hrs after onset | 5-7 hrs after onset |
| | lbs | weeks | of contractions | of contractions |
| 25-30 | 100-150 | 38-42 | 1-2 hrs after onset | 6-8 hrs after onset |
| | lbs | weeks | of contractions | of contractions |
| 25-30 | 150-180 | 38-42 | 1-3 hrs after onset | 5-7 hrs after onset |
| | lbs | weeks | of contractions | of contractions |
| 30-35 | 100-150 | 38-42 | 1-2 hrs after onset | 6-8 hrs after onset |
| | lbs | weeks | of contractions | of contractions |

At step 202, the processing unit 104 processes the plurality of records received at step 200, in order to identify a determinant factor as a cause for a variation in the rate of occurrence of delivery by cesarean section between hospital A and the established benchmark values. As mentioned above, the processing unit 104 uses statistical methods in order to select one or more determinant factors.

Again, using the very simple example of averages, the processing unit 104 may take the averages of each determinant factor in Table 1, and compare the averages to the relevant benchmark values to see if one or more of the determinant factors from Table 1 is not in-line with its corresponding benchmark value.

For example, in Table 1, the average age is 23.4, the average weight is 142 lbs, the average gestational age is 40.2 weeks, the average of the timing of the epidural is 1.4 hours after the onset of contractions and the average of when the decision to perform cesarean section was taken is 2.6 hours after the onset of contractions. Most of these average values fall within the benchmark values for woman between the ages of 20-25 having a weight between 100-150 lbs shown in Table 3, except the average of when the decision to perform cesarean section was taken. In Table 1, the average value for when the decision to perform cesarean section was taken was 2.6 hours after the onset of contractions, whereas according to the benchmark value, an acceptable time for deciding to perform a cesarean section is between 6-8 hours after the onset of contractions. As such, for the plurality of records shown above in Table 1, the determinant factor that is a candidate for causing a high rate of occurrence of delivery by cesarean section, is when the decision to perform a cesarean section was taken.

As mentioned above, in a specific example of implementation, in addition to identifying a candidate determinant factor, the processing unit 104 is further operative to derive an impact data element associated to the candidate determinant factor for indicating an amount of influence that the candidate determinant factor has on the variation in the rate of occurrence of the certain outcome.

At step 204, the processing unit 104 outputs a signal for conveying the selected determinant factor. In addition, in a specific example of implementation, the signal further conveys the impact data element derived by the processing unit 104. In the case where the processing unit 104 derives a set of determinant factors, at step 204, the processing unit 104 outputs a signal for conveying the identified set of determinant factors. In such a case, the signal can further convey impact data elements associated with each of the determinant factors in the set of determinant factors, or a single impact data element associated with the set of determinant factors.

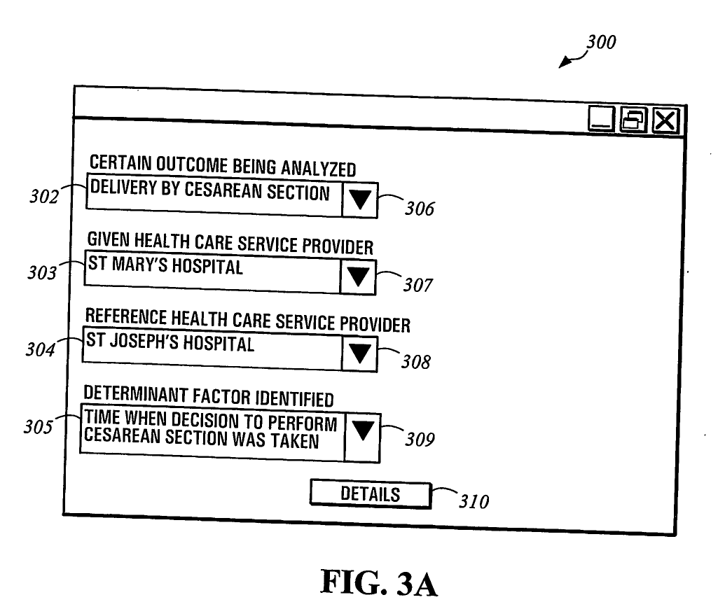

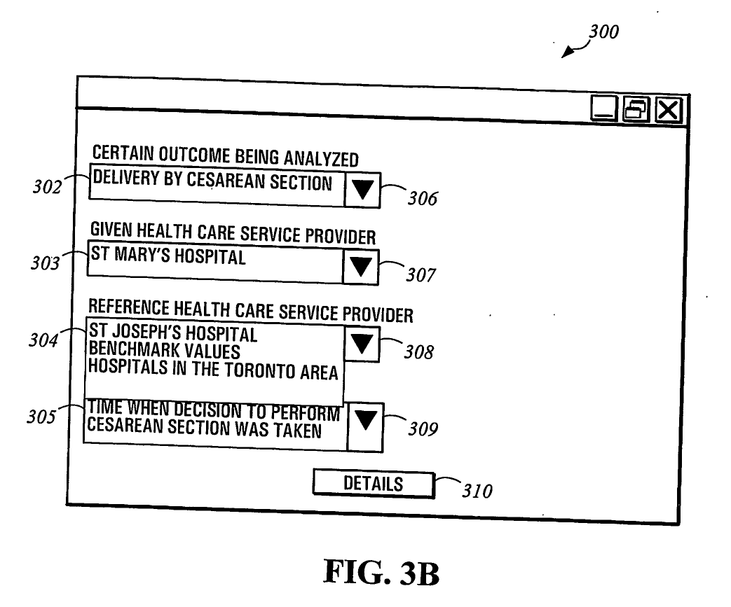

Shown in FIG. 3A, is a non-limiting example of a visual representation of how display unit 108 displays the determinant factor identified by the processing unit 104. In the specific example of implementation shown, the visual representation is in the form of a window 300 that could be shown on a computer display screen. The window 300 contains four data fields 302, 303, 304 and 305. Data field 302 is a text box that indicates the certain outcome being analysed. In the specific example shown, the certain outcome being analysed is delivery by cesarean section. Data field 303 is a text box that indicates the given health care service provider, which in the specific example shown is a hospital named St-Mary's. Data field 304 is a text box that indicates the reference health care service provider, which in the specific example shown is a hospital named St-Joseph's. Data field 305 is a text box that indicates the determinant factor that was selected by the processing unit 104, on the basis of the plurality of records it processed. In the specific example shown, the determinant factor is the time when the decision to perform the cesarean section was taken. Based on this information, the user of the system can review the plurality of records, and specifically the data elements corresponding to the determinant factor, and can decide whether action needs to be taken to adjust the nature of the service being provided so as to adjust the rate of occurrence of cesarean sections. For example, based on the outcome of above example, the health care professionals at St-Mary's hospital could be instructed not to make the decision to perform a cesarean section until the patient has experienced at least 6 hours of labour.

In the specific example of the visual representation shown in FIG. 3A, the fields 302, 303, 304 and 305 include respective drop down buttons 306, 307, 308 and 309 for enabling the user to select other items in each field. For example, drop down button 306 corresponding to data field 302 enables a user to select other outcomes to be analysed, such as Apgar scores, arterial cord gasses, new-born trauma, maternal trauma, and date and time of birth. Drop down button 307 corresponding to data field 303 enables a user to select other given health care service providers to be analysed, As shown in FIG. 3B, drop down button 308 corresponding to data field 304 enables a user to select other reference health care service providers against which the user can compare the given health care service provider. In the non-limiting example shown in FIG. 3B, by clicking drop down button 308, the user can select “benchmark values” and “hospitals in the Toronto area” against which to compare the given health care service provider. Referring back to FIG. 3A, field 305 includes drop down button 309, which enables the user to expand data field 305 in the case where there is more than one identified determinant factor, or in the case that there is a lot of text in data field 305 and more room is necessary. It should be understood that although the visual representations shown in FIGS. 3A and 3B includes drop down buttons, in an alternative embodiment, data fields 302, 303, 304 and 305 are text modifiable such that the user can simply type in other selections.

In addition to data fields 302, 303, 304 and 305, in the specific example shown in FIGS. 3A and 3B, window 300 further includes a button 310 for displaying more detailed information to a user. By selecting button 310 many different types of information can be presented to the user. Some non-limiting examples of the type of information that can be presented include graphs representing the discrepancies between data from the given health care service provider and the reference health care service provider, the actual records analysed and indications of how to modify the determinant factor identified by the processing unit 104. In addition data indicative of impact data elements for one or more determinant factors and well as combinations of determinant factors may be displayed to the user by selecting button 310.

Specific Physical Implementation

Those skilled in the art should appreciate that in some embodiments of the invention, all or part of the functionality for identifying a determinant factor that is a candidate for causing a variation in the rate of occurrence of a certain outcome between two health care service providers may be implemented as pre-programmed hardware or firmware elements (e.g., application specific integrated circuits (ASICs), electrically erasable programmable read-only memories (EEPROMs), etc.), or other related components.

In other embodiments of the invention, all or part of the functionality previously described herein with respect to the apparatus 101 for identifying at least one determinant factor may be implemented as software consisting of a series of instructions for execution by a computing unit. The series of instructions could be stored on a medium which is fixed, tangible and readable directly by the computing unit, (e.g., removable diskette, CD-ROM, ROM, PROM, EPROM or fixed disk), or the instructions could be stored remotely but transmittable to the computing unit via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

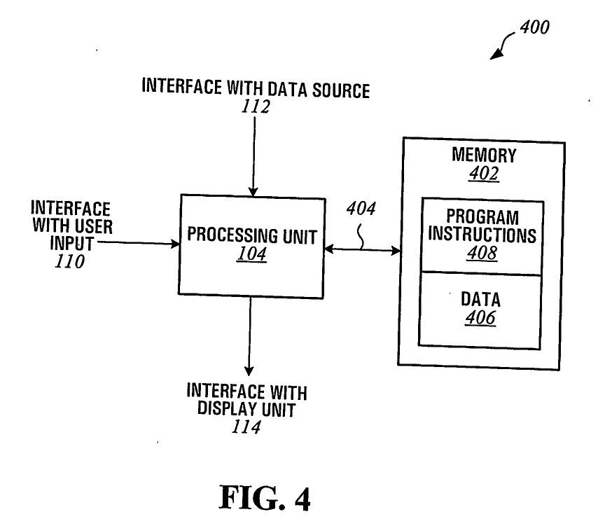

The apparatus 101 for identifying the determinant factor may be configured as a computing unit 400 of the type depicted in FIG. 4, including a processing unit 104 and a memory 402 connected by a communication bus 404. The memory 402 includes data 406, which could include data relating to reference health care service provider, for example, and program instructions 408. The processing unit 104 is adapted to process the data 406 and the program instructions 408 in order to implement the functional blocks described in the specification and depicted in the drawings. In a non-limiting implementation, the program instructions 408 implement the method described above. The computing unit 400 may also comprise a number of interfaces 110, 112 and 114 for receiving or sending data elements to external devices. For example, interface 110 is used for receiving data streams indicative of data entered at user interface 102. Interface 114 is for releasing the signal conveying the determinant factor identified by the processing unit 104. The released data is transmitted to display unit 106, such that display unit 106 conveys the data derived by processing unit 204 to a user.

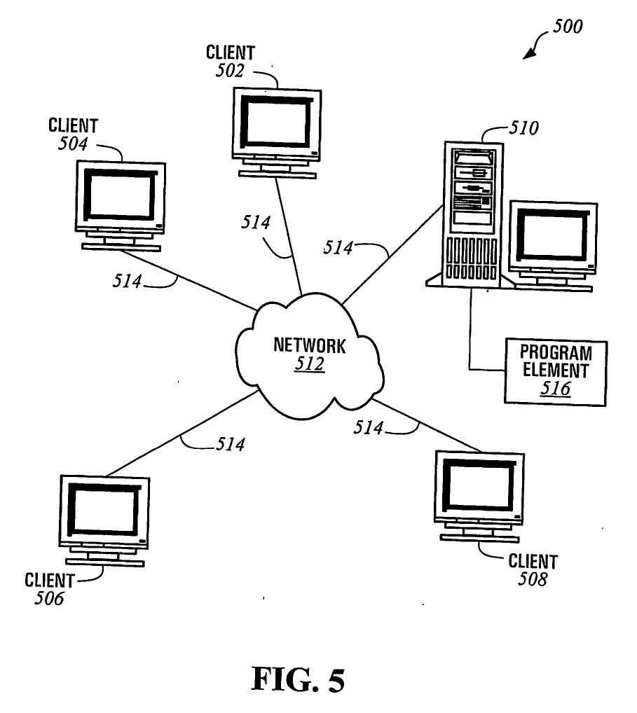

It will be appreciated that the system 100 may also be of a distributed nature where the data is collected at one location and transmitted over a network to a server unit implementing the method for evaluating variations in a certain outcome between a given health care service provider and a reference health care service provider, as described above. The server unit may then transmit a signal for causing a display unit to convey the determinant factor to the user. The display unit may be located in the same location as the processing is taking place, in the same location as the server unit or in yet another location. FIG. 5 illustrates a network-based client-server system 500 for analysing the variations in the rate of occurrence of a certain outcome at two different health care service providers. The client-server system 500 includes a plurality of client systems 502, 504, 506, 508 connected to a server system 510 through network 512. The communication links 514 between the client systems 502, 504, 506, 508 and the server system 510 can be metallic conductors, optical fibres or wireless, without departing from the spirit of the invention. The network 512 may be any suitable network including, but not limited to, a global public network such as the Intranet, a private network and a wireless network. The server 510 may be adapted to process and issue signals concurrently using suitable methods known in the computer related arts.

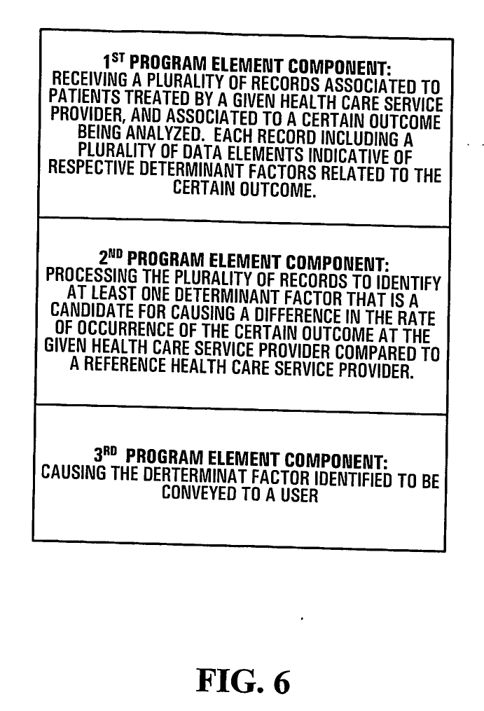

The server system 510 includes a program element 516 for execution by a CPU. Program element 516 implements similar functionality as program instructions 408 (shown in FIG. 4) and includes the necessary networking functionality to allow the server system 510 to communicate with the client systems 502, 504, 506, 508 over network 512. In a non-limiting implementation, program element 516 includes a number of program element components, each program element components implementing a respective portion of the functionality of the system 100, as described above. FIG. 6 shows a non-limiting example of the architecture of program element 516 at the server system. As shown, the program element 516 includes three program element components:
1. The first program element component 600 is executed on server system 510 and is for receiving a plurality of records associated to respective patients treated by the given health care service provider, and that are associated to the certain outcome being analyzed. Each record includes a plurality of data elements indicative of respective determinant factors related to the certain outcome.
2. The second program element component 602 is executed on server system 510 and is for processing the plurality of records in order to identify at least one determinant factor that is a candidate for causing a variation between a rate of occurrence of the certain outcome at the given health care service provider and a reference health care service provider.
3. The third program element component 604 is executed on server system 510 and is for transmitting the determinant factor identified to a client system so that the determinant factor is conveyed to a user.

In an alternative non-limiting example of implementation, program element 516 includes a set of 4 program element components.
1. The first program element component is executed on server system 510 and is for receiving a plurality of records associated to respective patients treated by the given health care service provider, each record including a plurality of data elements associated to respective determinant factors related to the certain outcome.
2. The second program element component is executed on server system 510 and is for processing the plurality of records in order to identify at least one determinant factor that is a candidate for causing a variation between the first rate of occurrence of the certain outcome and the second rate of occurrence of the certain outcome.
3. The third program element component is executed on server system 510 and is for sending messages to said client system for causing the client system to display information conveying the candidate determinant factor;
4. The fourth program element component is executed on one of the client systems 502, 504, 506, and 508 and is for receiving a message from the server system and for causing the client system to display the candidate determinant factor to a user.

In yet another alternative non-limiting example of implementation, a program element is provided for execution at the client systems 502, 504, 506, and 508 comprising:
1. a first program element component for causing a computer to deliver first information to a user. The first information prompts the user to enter at the computer a plurality of records associated to respective patients treated by the given health care service provider, each record including a plurality of data elements associated to respective determinant factors related to the certain outcome. The data may be entered manually or may be provided on a computer readable storage medium.
2. a second program element component responsive to the plurality of records for transmitting data over a computer network conveying the plurality of records to a server computing unit.
3. a third program element component responsive to a message including data indicative of at least one determinant factor received from the server computing unit for causing the computer to convey the candidate determinant factor to the user of the computer. The candidate determinant factor is a candidate for causing a variation between the second rate of occurrence of the certain outcome and the first rate of occurrence of the certain outcome.

Optionally, the program element provided for execution at the client systems 502, 504, 506, and 508 further comprises:
4. a fourth program element component adapted for causing the computer to deliver second information to the user, the second information prompting the user to enter at the computer information associated to the reference health care service provider. The information associated to the reference health care service provider may includes a plurality of records associated to respective patients treated by the reference health care service provider, each record including a plurality of data elements associated to respective determinant factors related to the certain outcome. Alternatively, the information associated to the reference health care service provider conveys benchmark parameters associated to the certain outcome. In yet another alternative implementation, the fourth program element component is adapted for prompting the user to select the reference health care service provider from a set of health care service providers.
5. a fifth program element component adapted for causing the computer to deliver third information to the user, the third information prompting the user to enter at the computer information associated to the certain outcome. In a non-limiting implementation, the fifth program element component is adapted for prompting the user to select the certain outcome from a set of outcomes.

Those skilled in the art should further appreciate that the program instructions may be written in a number of programming languages for use with many computer architectures or operating systems. For example, some embodiments may be implemented in a procedural programming language (e.g., “C”) or an object oriented programming language (e.g., “C++” or “JAVA”).

Although the present invention has been described in considerable detail with reference to certain preferred embodiments thereof, variations and refinements are possible without departing from the spirit of the invention. Therefore, the scope of the invention should be limited only by the appended claims and their equivalents.

1. An apparatus for evaluating variations in a certain outcome between a given health care service provider and a reference health care service provider, wherein the reference health care service provider is characterized by a first rate of occurrence of the certain outcome and the given health care service provider is characterized by a second rate of occurrence of the certain outcome, said apparatus comprising:
a) an input for receiving a plurality of records associated to respective obstetrics patients treated by the given health care service provider, each record including a plurality of data elements associated to respective determinant factors related to the certain outcome;
b) a processing unit coupled to said input, said processing unit being operative for:
i. processing said plurality of records to identify a set of determinant factors as candidates for causing a variation between the second rate of occurrence of the certain outcome and the first rate of occurrence of the certain outcome, the determinant factors being associated with respective impact data elements;
ii. selecting at least one determinant factor from the set of determinant factors at least in part on the basis of the impact data elements;
c) an output for releasing a signal conveying the at least one determinant factor.

2. An apparatus as defined in claim 1, wherein said processing unit is operative for processing said plurality of records to derive impact data elements associated to respective determinant factors in the set of determinant factors, each impact data element being indicative of an amount of influence that a corresponding determinant factor has on the variation between the second rate of occurrence of the certain outcome and the first rate of occurrence of the certain outcome.

3. An apparatus as defined in claim 2, wherein said impact data elements include percentage values.

4. An apparatus as defined in claim 2, wherein the signal released at said output conveys the at least one determinant factor and the corresponding impact data element.

5. An apparatus as defined in claim 1, wherein the at least one determinant factor is a modifiable determinant factor.

6. An apparatus as defined in claim 5, wherein said modifiable determinant factor is selected from the set consisting of patient characteristics, medical practices and a caregiver's threshold for intervention.

7. (canceled)

8. (canceled)

9. An apparatus as defined in claim 1, wherein the signal released at said output conveys the set of determinant factors and their associated impact data elements.

10. An apparatus as defined in claim 1, wherein said processing unit is operative for processing said plurality of records to derive an impact data element associated to a sub-set of said set of determinant factors, said impact data element being indicative of a combined influence that the determinant factors in said sub-set of determinant factors have on the variation between the second rate of occurrence of the certain outcome and the first rate of occurrence of the certain outcome.

11. An apparatus as defined in claim 10, wherein the signal released at said output conveys the sub-set of determinant factors and the impact data element.

12. An apparatus as defined in claim 1, wherein said input is further operative for receiving information data elements associated to said reference health care service provider, said information data elements being associated to respective determinant factors related to the certain outcome.

13. An apparatus as defined in claim 12, wherein said information data elements associated to said reference health care service provider include a plurality of records associated to respective obstetrics patients treated by the reference health care service provider.

14. An apparatus as defined in claim 12, wherein said information data elements associated to said reference health care service provider convey benchmark parameters associated to the certain outcome.

15. An apparatus as defined in claim 12, wherein said processing unit is operative for applying a statistical analysis method for selecting the at least one determinant factor.

16. An apparatus as defined in claim 15, wherein said statistical analysis method is selected from the set consisting of pattern recognition methods, data correlation techniques, linear regression, correlation coefficients, multivariate analysis, frequency distributions and random effects models.

17. (canceled)

18. An apparatus as defined in claim 1, wherein the certain outcome is a delivery by cesarean section.

19. An apparatus as defined in claim 1, wherein said output is operative for transmitting a signal conveying the at least one determinant factor to a display device.

20. An apparatus as defined in claim 19, wherein the display device is selected from the list consisting of a display screen and a printing apparatus.

21. A method for evaluating variations in a certain outcome between a given health care service provider and a reference health care service provider, wherein the reference health care service provider is characterized by a first rate of occurrence of the certain outcome and the given health care service provider is characterized by a second rate of occurrence of the certain outcome, said method comprising:
a) receiving a plurality of records associated to respective obstetrics patients treated by the given health care service provider, each record including a plurality of data elements associated to respective determinant factors related to the certain outcome;
b) processing said plurality of records to identify a set of determinant factors as candidates for causing a variation between the second rate of occurrence of the certain outcome and the first rate of occurrence of the elements;
c) selecting at least one determinant factor from the set of determinant factors at least in part on the basis of the impact data elements;
d) releasing a signal conveying the at least one determinant factor.

22. A method as defined in claim 21, further comprising processing said plurality of records to derive impact data elements associated to respective determinant factors in the set of determinant factors, each impact data element being indicative of an amount of influence that a corresponding determinant factor has on the variation between the second rate of occurrence of the certain outcome and the first rate of occurrence of the certain outcome.

23. A method as defined in claim 22, wherein said impact data elements include percentage values.

24. A method as defined in claim 22, further comprising releasing a signal conveying the at least one determinant factor and the corresponding impact data element.

25. A method as defined in claim 21, wherein the at least one determinant factor is a modifiable determinant factor.

26. A method as defined in claim 25, wherein said modifiable determinant factor is selected from the set consisting of patient characteristics, medical practices and caregiver's threshold for intervention.

27. (canceled)

28. (canceled)

29. A method as defined in claim 21, further comprising releasing a signal conveying the set of determinant factors and their associated impact data elements.

30. A method as defined in claim 21, further comprising processing said plurality of records to derive an impact data element associated to a sub-set of said set of determinant factors, said impact data element being indicative of a combined influence that the determinant factors in said set sub-set of determinant factors have on the variation between the second rate of occurrence of the certain outcome and the first rate of occurrence of the certain outcome.

31. A method as defined in claim 30, further comprising releasing a signal conveying the sub-set of determinant factors and the impact data element.

32. A method as defined in claim 21, further comprising receiving information data elements associated to the reference health care service provider, said information data elements being associated to respective determinant factors related to the certain outcome.

33. A method as defined in claim 32, wherein said information data elements associated to said reference health care service provider include a plurality of records associated to respective obstetrics patients treated by the reference health care service provider.

34. A method as defined in claim 32, wherein said information data elements associated to said reference health care service provider convey benchmark parameters associated to the certain outcome.

35. A method as defined in claim 32, wherein said processing involves applying a statistical analysis method for selecting the at least one determinant factor.

36. A method as defined in claim 35, wherein said statistical analysis method is selected from the set consisting of pattern recognition methods, data correlation techniques, linear regression, correlation coefficients, multivariate analysis, frequency distributions and random effects models.

37. An apparatus for evaluating variations in a certain outcome between a given health care service provider and a reference health care service provider, wherein the reference health care service provider is characterized by a first rate of occurrence of the certain outcome and the given health care service provider is characterized by a second rate of occurrence of the certain outcome, said apparatus comprising:
a) input means for receiving a plurality of records associated to respective obstetrics patients treated by the given health care service provider, each record including a plurality of data elements associated to respective determinant factors related to the certain outcome;
b) processing means coupled to said input, said processing means being operative for:
i. processing said plurality of records to identify a set of determinant factors as candidates for causing a variation between the second rate of occurrence of the certain outcome and the first rate of occurrence of the certain outcome, the determinant factors being associated with respective impact data elements;
ii. selecting at least on determinant factor from the set of determinant factors at least in part on the basis of the impact data elements;
c) output means for releasing a signal conveying the at least one determinant factor.

38. A server system for evaluating variations in a certain outcome between a given health care service provider and a reference health care service provider, wherein the reference health care service provider is characterized by a first rate of occurrence of the certain outcome and the given health care service provider is characterized by a second rate of occurrence of the certain outcome, said server system storing a program element for execution by a CPU, said program element comprising:
a) a first program element component for receiving a plurality of records associated to respective obstetrics patients treated by the given health care service provider, wherein each record includes a plurality of data elements associated to respective determinant factors related to the certain outcome;
b) a second program element component for processing the plurality of records in order to identify a set of determinant factors as candidates for causing a variation between the first rate of occurrence of the certain outcome and the second rate of occurrence of the certain outcome, the determinant factors being associated with respective impact data elements, said second program element also being operative for selecting at least on determinant factor from the set of determinant factors at least in part on the basis of the impact data elements;
c) a third program element component for transmitting the at least one determinant factor identified to a client system so that the at least one determinant factor is conveyed to a user.

39. A server system as defined in claim 38, wherein said second program element component is operative for processing said plurality of records to derive impact data elements associated to respective determinant factors in the set of determinant factors, each impact data element being indicative of an amount of influence that a corresponding determinant factor has on the variation between the second rate of occurrence of the certain outcome and the first rate of occurrence of the certain outcome.

40. A server system as defined in claim 39, wherein said impact data elements includes percentage values.

41. A server system as defined in claim 39, wherein said third program element component is operative for transmitting to a client server system the at least one determinant factor and the corresponding impact data element.

42. A server system as defined in claim 38, wherein the at least one determinant factor is a modifiable determinant factor.

43. A server system as defined in claim 42, wherein said modifiable determinant factor is selected from the set consisting of patient characteristics, medical practices and caregiver's threshold for intervention.

44. (canceled)

45. (canceled)

46. A server system as defined in claim 38, wherein said third program element component is operative for transmitting to a client server system the set of determinant factors and their associated impact data elements.

47. A server system as defined in claim 38, wherein said second program element component is operative for processing said plurality of records to derive an impact data element associated to a sub-set of said set of determinant factors, said impact data element being indicative of the combined influence that the determinant factors in said sub-set of determinant factors have on the variation between the second rate of occurrence of the certain outcome and the first rate of occurrence of the certain outcome.

48. A server system as defined in claim 47, wherein said third program element component is operative for transmitting to a client server system the sub-set of determinant factors and the impact data elements.

49. A server system as defined in claim 38, wherein said program element further comprises a fourth program element component for receiving information data elements associated to said reference health care service provider, said information data elements being associated to respective determinant factors related to the certain outcome.

50. A client-server system for evaluating variations in a certain outcome between a given health care service provider and a reference health care service provider, wherein the reference health care service provider is characterized by a first rate of occurrence of the certain outcome and the given health care service provider is characterized by a second rate of occurrence of the certain outcome, said client-server system comprising a client system and a server system, said client system and said server system operative to exchange messages over a data network, said server system storing a program element for execution by a CPU, said program element comprising:
a) a first program element component for execution on said server system for receiving a plurality of records associated to respective obstetrics patients treated by the given health care service provider, each record including a plurality of data elements associated to respective determinant factors related to the certain outcome;
b) a second program element component for execution on said server system for:
i. processing the plurality of records in order to identify a set of determinant factors as candidates for causing a variation between the first rate of occurrence of the certain outcome and the second rate of occurrence of the certain outcome, the determinant factors being associated with respective impact data elements;
ii. selecting at least one determinant factor from the set of determinant factors at least in part on the basis of the impact data elements,
c) a third program element component for execution on said server system for sending messages to said client system for causing said client system to display information conveying the at least one determinant factor;
d) a fourth program element component for execution on said client system for receiving messages from said server system, said fourth program element component being adapted for causing said client system to display the at least one determinant factor to a user.

51. A client-server system as defined in claim 50, wherein said fourth program element is operative for causing the at least one determinant factor to be displayed to a user on a display device.

52. A client-server system as defined in claim 51, wherein the display device is selected from the list consisting of a display screen and a printing apparatus.

53. A computer readable storage medium including a program element suitable for execution by a computing apparatus for evaluating variations in a certain outcome between a given health care service provider and a reference health care service provider, wherein the reference health care service provider is characterized by a first rate of occurrence of the certain outcome and the given health care service provider is characterized by a second rate of occurrence of the certain outcome, said computing apparatus comprising:
a) a memory unit;
b) a processor operatively connected to said memory unit, said program element when executing on said processor being operative for:
i. receiving a plurality of records associated to respective obstetrics patients treated by the given health care service provider, each record including a plurality of data elements associated to respective determinant factors related to the certain outcome;
ii. processing said plurality of records to identify a set of determinant factors as candidates for causing a variation between the second rate of occurrence of the certain outcome and the first rate of occurrence of the certain outcome, the determinant factors being associated with respective impact data elements;
iii. selecting at least one determinant factor from the set of determinant factors at least in part on the basis of the impact data elements;
iv. releasing a signal conveying the at least one determinant factor.

54. A computer readable storage medium as defined in claim 53, wherein said processor is operative for processing said plurality of records to derive impact data elements associated to respective determinant factors in the set of determinant factors, each impact data element being indicative of an amount of influence that a corresponding determinant factor has on the variation between the second rate of occurrence of the certain outcome and the first rate of occurrence of the certain outcome.

55. A computer readable storage medium as defined in claim 54, wherein said impact data elements include percentage values.

56. A computer readable storage medium as defined in claim 54, wherein the signal released conveys the at least one determinant factor and the corresponding impact data element.

57. A computer readable storage medium as defined in 53, wherein the at least one determinant factor is a modifiable determinant factor.

58. A computer readable storage medium as defined in claim 57, wherein said modifiable determinant factor is selected from the set consisting of patient characteristics, medical practices and caregiver's thresholds for intervention.

59. (canceled)

60. (canceled)

61. A computer readable storage medium as defined in claim 53, wherein the signal released conveys the set of determinant factors and their associated impact data elements.

62. A computer readable storage medium as defined in claim 53, wherein said processor is operative for processing said plurality of records to derive an impact data element associated to a sub-set of said set of determinant factors, said impact data element being indicative of the combined influence that the determinant factors in said sub-set of determinant factors have on the variation between the second rate of occurrence of the certain outcome and the first rate of occurrence of the certain outcome.

63. A computer readable storage medium as defined in claim 62, wherein the signal released conveys the sub-set of determinant factors and the impact data element.

64. A computer readable storage medium as defined in claim 53, wherein said processor is further operative for receiving information data elements associated to said reference health care service provider, said information data elements being associated to respective determinant factors related to the certain outcome.

65. A computer readable storage medium as defined in claim 64, wherein said information data elements associated to said reference health care service provider include a plurality of records associated to respective obstetrics patients treated by the reference health care service provider.

66. A computer readable storage medium as defined in claim 64, wherein said information data elements associated to said reference health care service provider convey benchmark parameters associated to the certain outcome.

67. A computer readable storage medium as defined in claim 64, wherein said processor is operative for applying a statistical analysis method for identifying the at least one determinant factor as the candidate for causing a variation between the second rate of occurrence of the certain outcome and the first rate of occurrence of the certain outcome.

68. A computer readable storage medium storing a program element for execution by a CPU, said program element being suitable for use in providing information related to variations in a certain outcome between a given health care service provider and a reference health care service provider, wherein the reference health care service provider is characterized by a first rate of occurrence of the certain outcome and the given health care service provider is characterized by a second rate of occurrence of the certain outcome, said program element comprising:
a) a first program element component for causing a computer to deliver first information to a user, the first information prompting the user to enter at the computer a plurality of records associated to respective obstetrics patients treated by the given health care service provider, each record including a plurality of data elements associated to respective determinant factors related to the certain outcome;
b) a second program element component responsive to the plurality of records for transmitting data over a computer network conveying said plurality of records to a server computing unit;
c) a third program element component responsive to a message including data indicative of at least one determinant factor received from the server computing unit for causing the computer to convey the at least one determinant factor to the user of the computer, the at least one determinant factor being a candidate for causing a variation between the second rate of occurrence of the certain outcome and the first rate of occurrence of the certain outcome.

69. A computer readable storage medium as defined in claim 68, wherein the message including data indicative of at least one determinant factor received from the server computing unit, further includes an impact data element indicative of an amount of influence that said at least one determinant factor has on the variation between the second rate of occurrence of the certain outcome and the first rate of occurrence of the certain outcome.

70. A computer readable storage medium as defined in claim 69, wherein the third program element component is responsive to the message for causing the computer to convey to the user the at least one determinant factor and the impact data element.

71. A computer readable storage medium as defined in 68, wherein the at least one determinant factor is a modifiable determinant factor.

72. A computer readable storage medium as defined in claim 68, wherein the message received from the server computing unit includes data indicative of a set of determinant factors, the determinant factors in the set of determinant factors being candidates for causing a variation between the second rate of occurrence of the certain outcome and the first rate of occurrence of the certain outcome.

73. A computer readable storage medium as defined in claim 72, wherein the message indicative of the set of determinant factors includes impact data elements associated to respective determinant factors in said set of determinant factors, each impact data element being indicative of an amount of influence that its associated determinant factor has on the variation between the second rate of occurrence of the certain outcome and the first rate of occurrence of the certain outcome.

74. A computer readable storage medium as defined in claim 74, wherein the third program element component is responsive to the message for causing the computer to convey to the user the set of determinant factors and their associated impact data elements.

75. A computer readable storage medium as defined in claim 73, wherein the message including data indicative of said set of determinant factors, further includes an impact data element indicative of the influence that said set of determinant factors have on the variation between the second rate of occurrence of the certain outcome and the first rate of occurrence of the certain outcome.

76. A computer readable storage medium as defined in claim 75, wherein the third program element component is responsive to the message for causing the computer to convey to the user the set of determinant factors and the impact data element.

77. A computer readable storage medium as defined in claim 68, wherein said program element further comprises a fourth program element component adapted for causing the computer to deliver second information to the user, the second information prompting the user to enter at the computer information associated to the reference health care service provider.

78. A computer readable storage medium as defined in claim 77, wherein said information associated to the reference health care service provider includes a plurality of records associated to respective obstetrics patients treated by the reference health care service provider, each record including a plurality of data elements associated to respective determinant factors related to the certain outcome.

79. A computer readable storage as defined in claim 77, wherein said information associated to said reference health care service provider conveys benchmark parameters associated to the certain outcome.

80. A computer readable storage medium as defined in claim 77, wherein said fourth program element component is adapted for prompting the user to select the reference health care service provider from a set of health care service providers.

81. A computer readable storage medium as defined in claim 68, wherein said program element further comprises a fifth program element component adapted for causing the computer to deliver third information to the user, the third information prompting the user to enter at the computer information associated to the certain outcome.

82. A computer readable storage medium as defined in claim 81, wherein said fifth program element component is adapted for prompting the user to select the certain outcome from a set of outcomes.
